(19) United States
(12) Patent Application Publication
(10) Pub. No.: US 2024/0161553 A1
(43) Pub. Date: May 16, 2024

(54) Management Method and Management System for Managing Power Storage Device, and Computer Device

(71) Applicant: TOYOTA JIDOSHA KABUSHIKI KAISHA, Toyota-shi (JP)

(72) Inventors: Yasuhide KURIMOTO, Kasugai-shi (JP); Tomoyoshi UEKI, Toyota-shi (JP); Yuko TERASAWA, Tokyo-to (JP); Masahiro KAGAMI, Nagoya-shi (JP); Hiroshi YAMASAKI, Nagoya-shi (JP); Kenji ZAITSU, Nisshin-shi (JP); Yoshihiko ENDO, Tokyo-to (JP)

(21) Appl. No.: 18/474,450

(22) Filed: Sep. 26, 2023

(30) Foreign Application Priority Data
Nov. 14, 2022 (JP) 2022-181991

(51) Int. Cl. G07C 5/00; G06Q 30/0645; G06Q 40/08; G07C 5/08

(52) U.S. Cl. CPC G07C 5/008; G06Q 30/0645; G06Q 40/08; G07C 5/0808; G06Q 2220/00

(57) ABSTRACT

A management method for managing a power storage device includes: when information indicating that an accident has occurred with regard to a target vehicle including a power storage device, obtaining first owner information indicating an owner of the power storage device from a data management device that manages information about a plurality of vehicles including the target vehicle; specifying the owner of the power storage device using the obtained first owner information; and providing, to a terminal of the specified owner of the power storage device, a notification that informs the occurrence of the accident of the target vehicle.

### CROSS REFERENCE TO RELATED APPLICATIONS

This nonprovisional application is based on Japanese Patent Application No. 2022-181991 filed on Nov. 14, 2022 with the Japan Patent Office, the entire contents of which are hereby incorporated by reference.

### BACKGROUND

### Field

The present disclosure relates to a management method and a management system for managing a power storage device, and a computer device.

### Description of the Background Art

Japanese Patent Laying-Open No. 2022-064527 discloses the following technology: when an impact of a predetermined value or more is detected by an impact detection sensor that detects a magnitude of impact applied to a vehicle, an electronic control unit employing an auxiliary battery as a power supply for driving lowers only a voltage of a battery cell selected in advance in a battery module.

### SUMMARY

In recent years, electrification of vehicles has been advanced in every country of the world, and attention is being drawn particularly to technologies of four fields called “CASE” (Connected, Autonomous/Automated, Shared and Electric). A vehicle lease service (including a vehicle sharing service) that leases a vehicle to a user is also one of them. However, in Japanese Patent Laying-Open No. 2022-064527, sufficient review has not been made with regard to occurrence of an accident of a leased vehicle or occurrence of an accident of a vehicle having a leased power storage device mounted thereon. Specifically, according to the technology described in Japanese Patent Laying-Open No. 2022-064527, the user of the vehicle can know the occurrence of the accident; however, when the power storage device thereof is leased, it is difficult for an owner of the power storage device to know the occurrence of the accident.

The present disclosure has been made to solve the above problem, and has an object to accurately inform, when an accident of a vehicle occurs, occurrence of the accident to an owner of a power storage device included in the vehicle.

According to a first aspect of the present disclosure, the following management method for managing a power storage device is provided.

(Item 1) The management method for managing a power storage device includes: when information indicating that an accident has occurred with regard to a vehicle (hereinafter also referred to as “target vehicle”) including a power storage device is obtained, obtaining first owner information indicating an owner of the power storage device of the target vehicle from a data management device that manages information about a plurality of vehicles including the target vehicle; specifying the owner of the power storage device of the target vehicle using the obtained first owner information; and providing, to a terminal of the specified owner of the power storage device, a notification that informs the occurrence of the accident of the target vehicle including the power storage device.

In the management method, when the accident has occurred with regard to the target vehicle, the owner of the power storage device included in the target vehicle is specified. Then, the notification that informs the occurrence of the accident of the target vehicle including the power storage device is provided to the terminal of the owner of the power storage device. Thus, at the time of occurrence of the accident of the vehicle, the occurrence of the accident can be accurately informed to the owner of the power storage device included in the target vehicle.

The target vehicle may be an electrically powered vehicle (xEV) that utilizes electric power as a whole or part of motive power source. Examples of the xEV include a BEV (battery electric vehicle), an HEV (hybrid electric vehicle), a PHEV (plug-in hybrid electric vehicle), a FCEV (fuel cell electric vehicle), and the like.

The method according to item 1 may have a configuration according to item 2 below.

(Item 2) The management method for managing a power storage device according to item 1 further has the following feature. The data management device manages information indicating an owner of a vehicle-mounted power storage device and an owner of a vehicle body portion with regard to each of the plurality of vehicles. The management method includes: when information indicating that an accident has occurred between the target vehicle and another vehicle is obtained, obtaining, from the data management device, the first owner information indicating the owner of the power storage device of the target vehicle and second owner information indicating an owner of a vehicle body portion of the other vehicle; specifying a user of the other vehicle using the obtained second owner information; and providing, to a terminal of the specified user of the other vehicle, a notification that informs the owner of the power storage device of the target vehicle.

According to the above-described method, the owner of the power storage device of the target vehicle can be informed to the other party in the accident (user of the other vehicle). Therefore, when the power storage device of the target vehicle is damaged by the accident, a negotiation about compensation for the damage can be facilitated between the other party in the accident and the owner of the power storage device of the target vehicle.

The vehicle user may be provided with, for example, a vehicle in any one of the following three manners of utilization: partial lease; full lease; and full ownership. The partial lease is a manner of utilization in which the vehicle body portion (portion other than the power storage device) is owned by the user and the power storage device is provided to the user by lease. The full lease is a manner of utilization in which both the vehicle body portion and the power storage device are provided to the user by lease. The full ownership is a manner of utilization in which both the vehicle body portion and the power storage device are owned by the user.

When the manner of utilization of the other vehicle is the partial lease or the full ownership, the user of the other vehicle can be directly specified from the second owner information. When the manner of utilization of the other vehicle is the full lease, the user of the other vehicle can be specified by making an inquiry to a lease business entity (owner of the vehicle body portion of the other vehicle) using the second owner information, for example.

According to a certain embodiment, there is provided a program for causing a computer to perform the management method for managing a power storage device according to item 1 or 2. In another aspect, a computer device for distributing the program is provided.

According to a second aspect of the present disclosure, the following computer device is provided.

(Item 3) The computer device includes a processor and a storage that stores a program for causing the processor to perform the management method for managing a power storage device according to item 1 or 2.

According to the computer device described above, the above-described management method for managing a power storage device is suitably performed.

According to a third aspect of the present disclosure, the following management system for managing a power storage device is provided.

(Item 4) The management system for managing a power storage device includes the computer device according to item 3 and the data management device. The data management device includes: a storage that stores a distributed ledger; and a controller that registers, in the distributed ledger, transaction data including information indicating an owner of a vehicle-mounted power storage device with regard to each of the plurality of vehicles.

In the above-described system, since the data is managed using the distributed ledger technology (DLT), it is possible to suppress tampering of data. At present, authentication information (such as automobile inspection and registration information) of a vehicle as provided by an authority of each country does not include information indicating an owner of a vehicle-mounted power storage device. In the above-described system, secure data management can be attained, with the result that owner information as highly reliable as the information provided by the authority can be provided to the computer device. Such owner information may satisfy perfection against a third party. The controller may register only electronically authenticated information in the distributed ledger.

The management system for managing a power storage device according to item 4 may have a configuration according to item 5 or 6 described below.

(Item 5) The management system according to item 4 further has the following feature. The computer device is a first server that provides an insurance service for damage of a power storage device for a vehicle. The target vehicle for which the accident has occurred transmits an accident occurrence signal informing the occurrence of the accident, damage information indicating a degree of damage of the power storage device, and accident data indicating a situation of the target vehicle when the accident has occurred. When the first server receives the accident occurrence signal, the first server performs: determining a degree of negligence of a user of the target vehicle with regard to the accident based on the accident data, and determining an insurance benefit to be paid by the insurance service, based on the damage information and the degree of negligence.

According to the above-described system, the insurance benefit can be facilitated to be appropriately determined based on the degree of damage of the power storage device and the degree of negligence of the vehicle user with regard to the accident. Further, the vehicle user can be facilitated to receive the insurance service.

The first server may transmit the determined insurance benefit to at least one of a below-described second server and a user terminal of the target vehicle for which the accident has occurred. The user terminal may be a vehicle-mounted terminal on the target vehicle or a mobile terminal carried by the user of the target vehicle. The user terminal may be associated with the target vehicle in advance and may be registered in at least one of the first server and the second server.

(Item 6) The management system according to item 4 or 5 further has the following feature. The management system further includes a plurality of exchange stations that each exchange a power storage device for a vehicle. The terminal of the owner of the power storage device is a second server that provides a lease service for leasing a power storage device for a vehicle. When the second server receives the notification that informs the occurrence of the accident of the target vehicle, the second server permits one or more of the exchange stations to exchange the power storage device.

According to the above-described system, when the accident has occurred with regard to the target vehicle, the power storage device mounted on the target vehicle can be facilitated to be exchanged by the exchange station.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram for illustrating an overview of a management system for managing a power storage device according to an embodiment of the present disclosure.

FIG. 2 is a diagram for illustrating a configuration of a data management device shown in FIG. 1.

FIG. 3 is a diagram showing exemplary DAG (Directed Acyclic Graph) data.

FIG. 4 is a diagram showing exemplary block chain data.

FIG. 5 is a diagram for illustrating a configuration of a vehicle shown in FIG. 1.

FIG. 6 is a flowchart showing control at the time of occurrence of an accident in a management method for managing a power storage device according to the embodiment of the present disclosure.

FIG. 7 is a flowchart showing a process for providing an insurance service in the management method according to the embodiment of the present disclosure.

FIG. 8 is a flowchart showing control for battery exchange as performed by a server of a lease business entity in the management method for managing a power storage device according to the embodiment of the present disclosure.

FIG. 9 is a flowchart showing control for battery exchange as performed by a target vehicle and an exchange station terminal in the management method for managing a power storage device according to the embodiment of the present disclosure.

FIG. 10 is a diagram for illustrating configuration and operation of an exchange station according to the embodiment of the present disclosure.

### DESCRIPTION OF THE PREFERRED EMBODIMENTS

Embodiments of the present disclosure will be described in detail with reference to figures. In the figures, the same or corresponding portions are denoted by the same reference characters and will not be described repeatedly.

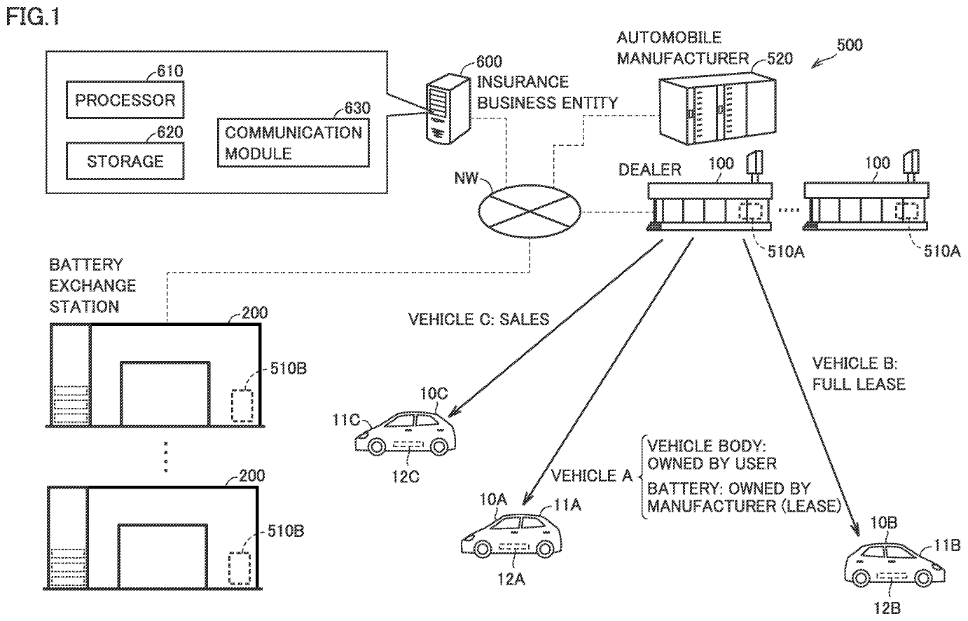

FIG. 1 is a diagram for illustrating an overview of a management system for managing a power storage device according to the present embodiment. The management system shown in FIG. 1 includes dealers 100, battery exchange stations (hereinafter referred to as “BStas”) 200, a management center 500, and an insurance server 600. In general, a battery exchange station is also referred to as a “battery replacement station” or a “BSS (Battery Swapping Station)”.

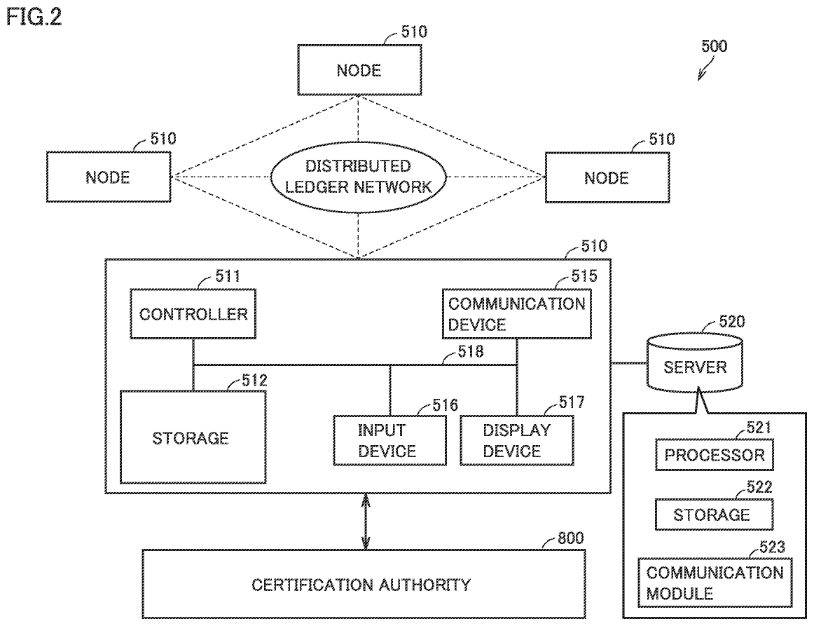

Management center 500 includes a plurality of nodes 510 and a server 520. In the present embodiment, a node 510 is installed in each of dealers 100 and BStas 200. Hereinafter, node 510 installed in dealer 100 will be referred to as “node 510A”, and node 510 installed in BSta 200 will be referred to as “node 510B”. It should be noted that when these are not distinguished from each other, they are collectively referred to as “node 510”. Each of nodes 510A, 510B has a below-described configuration shown in FIG. 2. However, nodes 510A, 510B may be customized differently in accordance with installation locations (dealer 100, BSta 200) and purposes of use.

Server 520 is a server that provides a lease service for leasing a power storage device for a vehicle (such as an xEV). Server 520 manages information about the lease service. Server 520 belongs to, for example, an automobile manufacturer. In the present embodiment, the automobile manufacturer also serves as a lease business entity. Insurance server 600 is a server that provides an insurance service for damage of a power storage device for a vehicle (such as an xEV). This insurance service is a service for compensating for damage of a power storage device mounted on a vehicle. Insurance server 600 manages information about the insurance service. Insurance server 600 belongs to, for example, an insurance business entity. Insurance server 600 cooperates with server 520 to provide an insurance service for damage of a power storage device leased by the lease service. Insurance server 600 and server 520 correspond to examples of the “first server” and the “second server” according to the present disclosure, respectively.

The lease service employs a plurality of types of lease methods including a partial lease method and a full lease method. The partial lease method is a lease method in which only a power storage device for a vehicle is leased. A user to have a leased power storage device through the partial lease method prepares by himself/herself a portion (vehicle body portion) of a vehicle other than the power storage device. The user can mount, on the vehicle body owned by the user, the power storage device borrowed from the lease business entity. With the power storage device mounted on the vehicle body, the xEV can travel. When the contract of the partial lease is expired, the user returns only the power storage device to the lease business entity. On the other hand, the full lease method is a lease method in which the whole vehicle (i.e., both the vehicle body portion and the power storage device) are leased. When the full lease contract is expired, the user returns not only the power storage device but also the whole vehicle to the lease business entity.

The automobile manufacturer sells or leases a vehicle through dealer 100. Dealer 100 not only sells a vehicle manufactured by the automobile manufacturer, but also provides the lease service described above. Dealer 100 leases at least one of a vehicle body and a power storage device provided by the automobile manufacturer. Dealer 100 may lease a power storage device 12A of a vehicle 10A shown in FIG. 1 to a user through, for example, the partial lease method. In this case, vehicle 10A corresponds to a partial lease vehicle (hereinafter also referred to as “vehicle A”), and a vehicle body 11A of vehicle 10A is an object owned by the user. Further, power storage device 12A of vehicle 10A is provided to the user by the lease and is an object owned by the automobile manufacturer. Dealer 100 may lease a vehicle 10B shown in FIG. 1 to a user through, for example, the full lease method. In this case, vehicle 10B corresponds to a full lease vehicle (hereinafter also referred to as “vehicle B”). The whole of vehicle 10B (vehicle body 11B and power storage device 12B) is provided to the user by the lease and is an object owned by the automobile manufacturer. Dealer 100 may sell, for example, a vehicle 10C shown in FIG. 1 to a user. In this case, vehicle 10C corresponds to a sales vehicle (hereinafter also referred to as “vehicle C”). The whole of vehicle 10C (a vehicle body 11C and a power storage device 12C) is sold to the user and is an object owned by the user.

In the present embodiment, an insurance fee is included in a lease fee (for example, monthly lease fee) billed to the vehicle user by dealer 100. That is, each of vehicles A and B is enrolled in an insurance provided by insurance server 600 (more specifically, insurance for damage of the power storage device). When the power storage device mounted on each of vehicles A and B is damaged, the insurance covers the damage of the power storage device mounted thereon. The insurance service compensates for the damage of the power storage device. Although details will be described later, insurance server 600 determines an insurance benefit to be paid by the insurance service and notifies the determined insurance benefit to server 520. The determined insurance benefit is paid from the insurance business entity to the lease business entity. When a monetary amount of loss due to the damage of the power storage device is larger than the insurance benefit, the lease business entity bills an amount of difference therebetween to the vehicle user. Since the insurance is for lease, vehicle C is not enrolled in the insurance. However, vehicle C may be enrolled in another insurance.

BSta 200 is configured to exchange a power storage device for a vehicle (such as an xEV). Node 510B of BSta 200 is connected to a communication network NW by wire, for example. In the present embodiment, a battery (more specifically, a secondary battery) is employed as the power storage device. However, the power storage device may be any device that can store electric power, and examples of the power storage device include the secondary battery, a large-capacity capacitor, and the like.

The management system for managing a power storage device according to the present embodiment includes the plurality of dealers 100. These dealers 100 are disposed at respective locations in a management area managed by the management system so as to construct a network of sales/lease sites to cover a whole of the management area. Further, the management system includes the plurality of BStas 200. These BStas 200 are disposed at respective locations in the management area managed by the management system so as to construct a network of battery exchange sites to cover the whole of the management area. Further, each BSta 200 may function as a vehicle repair factory. Each BSta 200 may be configured to repair the vehicle body. Dealer 100 and BSta 200 may be disposed at the same location (or nearby locations).

Insurance server 600 includes a processor 610, a storage 620, and a communication module 630. Processor 610 includes, for example, a CPU (Central Processing Unit). Storage 620 is configured to retain stored information. Storage 620 may include an HD (hard disk) drive or an SSD (Solid State Drive). Communication module 630 is connected to communication network NW by wire, for example. Each node 510, server 520, and insurance server 600 are configured to communicate with one another via communication network NW. Communication network NW is, for example, a wide area network constructed by the Internet and a wireless base station. Communication network NW may include a mobile phone network.

Management center 500 is a data management device that manages information about a plurality of vehicles by using a distributed ledger technology. All the pieces of information from start of operation of the distributed ledger to the present time are recorded in the distributed ledger. FIG. 2 is a diagram for illustrating a configuration of management center 500.

Referring to FIG. 2, management center 500 includes: the plurality of nodes 510 that forms a distributed ledger network (hereinafter referred to as “DLN”); and server 520 that can communicate with each node 510. Each node 510 is configured to communicate with a certification authority 800. Server 520 includes a processor 521, a storage 522, and a communication module 523. Although four nodes 510 are shown in FIG. 2, the number of nodes 510 can be changed as appropriate.

Node 510 according to the present embodiment is a stationary computer (for example, a server). Node 510 includes a controller 511, a storage 512, a communication device 515, an input device 516, and a display device 517, which are connected to a bus 518.

Controller 511 includes, for example, a processor (not shown), a ROM (Read Only Memory), and a RAM (Random Access Memory), and is configured to perform information processing. Storage 512 includes, for example, a hard disk or a flash memory, and is configured to retain information. Storage 512 stores a program to be executed by the processor of controller 511, and information to be used by the program. Communication device 515 is connected to communication network NW (FIG. 1).

Controller 511 exchanges information with an external device through communication device 515. Communication device 515 is configured to communicate with each of the other nodes 510, server 520, and certification authority 800. Input device 516 transmits, to controller 511, information (for example, an instruction or parameter value) input by the user. Display device 517 displays information to the user in accordance with a control command from controller 511.

Storage 512 further stores: a pair of private key and public key generated by controller 511; and an electronic certificate issued from certification authority 800. Specifically, controller 511 generates the private key and the public key paired therewith, and transmits the generated public key to certification authority 800. Certification authority 800 includes a server belonging to a certification body. Certification authority 800 generates the electronic certificate for the public key received from node 510 (applicant for the electronic certificate), and issues the electronic certificate including the public key to node 510. Node 510 transmits the issued electronic certificate to the DLN. The electronic certificate is used to verify validity of an electronic signature as described later.

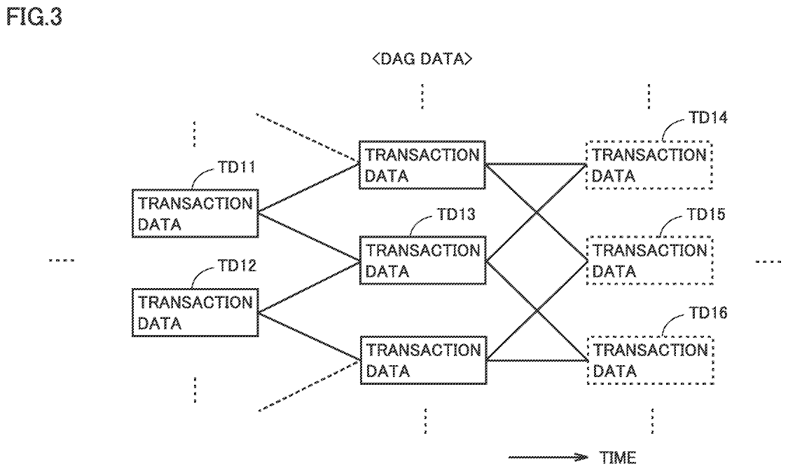

In the data management by management center 500, the distributed ledger technology utilizing DAG (Directed Acyclic Graph) may be employed. In such an implementation, each of storage 522 of server 520 and storage 512 of each node 510 stores DAG data described below. FIG. 3 is a diagram showing exemplary DAG data.

As shown in FIG. 3, the DAG data has such a configuration that one piece of transaction data is connected to a plurality of pieces of transaction data in one direction so as to avoid them from being cyclic. Storage 512 of each node 510 included in the DLN stores the DAG data. Thus, tampering of data is suppressed. Even when the DAG data is tampered with by a certain user, the tampering is immediately detected based on the DAG data held by the plurality of other users.

In the example shown in FIG. 3, each transaction data is connected to pieces of transaction data corresponding to two transactions that have occurred before the foregoing transaction data. That is, each transaction data includes a hash value of data for a past transaction. Hereinafter, pieces of transaction data TD11 to TD16 in FIG. 3 will be simply denoted as “TD11” to “TD16”, respectively. In the DAG data shown in FIG. 3, a transaction corresponding to TD13 is newer than a transaction corresponding to each of TD11, TD12, and a transaction corresponding to each of TD14 to TD16 is newer than transaction corresponding to TD13. A procedure of adding new information (for example, owner information described later) to the DAG data will be described below.

Referring to FIGS. 2 and 3, first, the user of node 510 operates input device 516 to store, into storage 522 of server 520, data (hereinafter referred to as “target data”) for information to be newly added. In response to this process (transaction for data addition), node 510 generates TD13 corresponding to this process (transaction). Controller 511 may generate TD 13 including the target data having the electronic signature attached therewith by, for example, the following method.

Controller 511 obtains the target data from server 520 and hashes the target data using a hash function. Then, controller 511 reads out the private key from storage 512 and generates an electronic signature using the private key. Then, controller 511 encrypts the hashed target data using the private key to generate TD13 including the target data having the electronic signature attached therewith. Electronic signatures of a plurality of persons to sign a contract may be added to the target data indicating the content of the contract. Each of the other nodes 510 in the DLN may decrypt the encrypted electronic signature using the public key included in the electronic certificate (specifically, the public key paired with the private key) and may verify the validity of the electronic signature based on the result of the decryption. However, it is not essential to provide the electronic signature to the target data in generating the transaction data including the target data.

When generating TD13, node 510 selects, for example, TD11, TD12 from the pieces of past transaction data, and verifies the contents of selected TD11, TD12. The selection may be made randomly from the pieces of past transaction data, or may be made using a selection algorithm such as a Markov chain Monte Carlo method. The verification may be performed by a verification method using the electronic signature included in the transaction data, or another known verification method. Node 510 may retrospectively verify transaction data approved directly or indirectly by TD11, TD12.

When there is no invalid transaction data as a result of the verification, node 510 hashes verified TD11, TD12, and includes these hash values in TD13. The inclusion of these hash values in TD13 means that node 510 has approved TD11, TD12 at the time of generation of TD13. Generated TD13 further includes the hash value of the target data (data for new information). The hash value is obtained as a result of hashing the target data (for example, document data) by node 510 using a hash function.

Then, node 510 transmits, to the DLN, TD13 generated, verified and approved as described above. Thus, TD13 is added to the DAG data. The updated portion of the DAG data is written by each node 510 in the DLN into the distributed ledger (for example, a consortium distributed ledger). Thus, the new transaction data is registered in the distributed ledger.

Node 510 may obtain a time stamp token for generated TD13 (including the target data) from certification authority 800. In response to a request from node 510, certification authority 800 may issue a time stamp token combined with time information that is based on a time source having traceability in the international standard time. Controller 511 may hash the timestamp token using a hash function and may register the hashed timestamp token in the distributed ledger (for example, DAG data). With this time stamp token, it can be proved that the target data exists in the distributed ledger at that time.

TD13 added to the DAG data is thereafter verified and approved by other nodes 510 as described above. In the example shown in FIG. 3, TD13 is approved by each of TD14, TD16. It should be noted that a cumulative load may be set to each transaction data in the DAG data. The cumulative load indicates a probability that the transaction data is valid. The cumulative load may indicate, for example, the number of other pieces of transaction data that approve the foregoing transaction data.

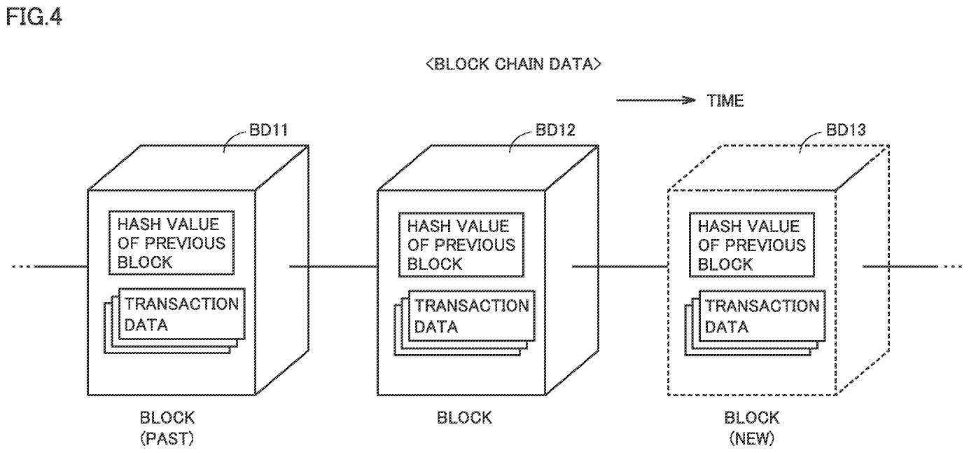

In the data management by management center 500, a distributed ledger technology using a block chain (hereinafter referred to as “BLC”) may be employed. In such an implementation, each of storage 522 of server 520 and storage 512 of each node 510 stores BLC data described below. FIG. 4 is a diagram showing exemplary BLC data.

As shown in FIG. 4, the BLC data is constituted of a series of a plurality of blocks. Blocks BD11 to BD13 in FIG. 4 are newer toward the right side. When these are arranged in the order from the oldest one, the order is as follows: BD11, BD12, and BD13. The BLC data indicates a history of transactions. Storage 512 of each node 510 included in the DLN stores the BLC data. Thus, tampering of data is suppressed. A procedure of adding new information to the BLC data will be described below.

Referring to FIGS. 2 and 4, first, the user of node 510 operates input device 516 to store the target data (data for new information) into storage 522 of server 520. In response to this process (transaction for data addition), node 510 generates transaction data corresponding to this process (transaction). Specifically, node 510 hashes the target data using a hash function, and generates transaction data including a numeric value (hash value) obtained as a result of the hashing. Controller 511 may generate the transaction data including the target data having the electronic signature attached therewith in the above-described procedure.

Node 510 transmits the transaction data generated as described above to the DLN. This transaction data has not been authenticated yet and is collected in new block BD13. The transaction data is not recognized as being valid only when the transaction data flows to the DLN. The transaction data becomes valid only when the transaction data is added to the distributed ledger (BLC data) held in each node 510 in the DLN.

When a predetermined requirement is satisfied, new block BD13 is added to existing blocks BD11, BD12. For example, new block BD13 is added to the BLC data by a mining process called POW (Proof of Work). Thus, the new transaction data is registered in the distributed ledger. The POW is a mechanism for competing addition of new block BD13 among the plurality of nodes. The nodes participating in the POW are generally called minors. A minor having generated new block BD13 most quickly is given a reward. With a consensus building algorithm using such a mechanism, resistance of the BLC data against tampering is secured.

As described above, each of nodes 510 included in management center 500 includes: storage 512 that stores, for example, the distributed ledger that uses the DAG or the BLC; and controller 511 that registers the transaction data in the distributed ledger. Management center 500 stores the pieces of information (transaction data) about the plurality of vehicles sold or leased by dealers 100 at the respective sites with the pieces of information being distinguished by respective pieces of vehicle identification information (vehicle ID). Each vehicle ID may be a VIN (Vehicle Identification Number).

In the present embodiment, when dealer 100 sells or leases a vehicle, node 510A of dealer 100 writes transaction data in the distributed ledger. Thus, owner information and insurance information corresponding to the sales contract or the lease contract are written in the distributed ledger. Further, a time stamp token for the transaction data is registered in the distributed ledger.

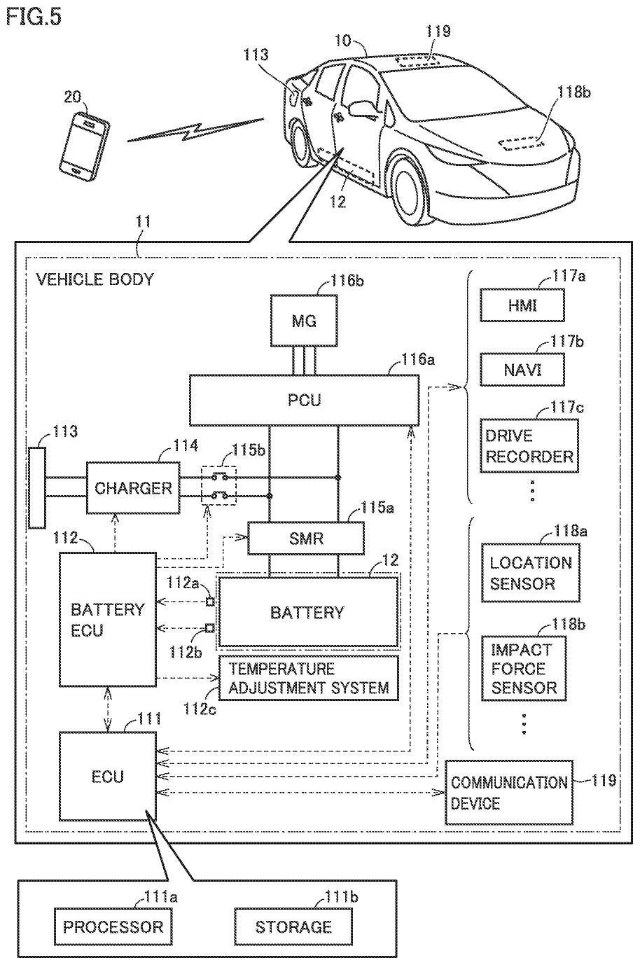

The transaction data includes, for example, the vehicle ID, specification information, the owner information, the insurance information, the hash value of the target data, the time information, registered-person information, the hash value of the past transaction data, and the electronic signature. The specification information indicates a specification of each of the vehicle body portion and the power storage device with regard to the vehicle specified by the vehicle ID. The owner information indicates the owner of the power storage device mounted on the vehicle and the owner of the vehicle body portion of the vehicle with regard to the vehicle specified by the vehicle ID. The insurance information indicates an insurance in which the vehicle specified by the vehicle ID is enrolled and an insurance business entity for the insurance. The insurance information for each of vehicles A and B indicates a communication address of insurance server 600 as a contact of the insurance business entity with which the vehicle user has made a contract. The electronic signature includes, for example, an electronic signature of each of the vehicle user, the lease business entity, and the insurance business entity. The vehicle ID, the specification information, the owner information, and the insurance information for the sold or leased vehicle are also written in a storage (for example, a below-described storage 111b shown in FIG. 5) of the vehicle.

The owner information includes identification information of the owner and contact information of the owner. The identification information of the owner includes information for specifying the owner (for example, name, corporate name, identification number, or identification symbol). The contact information of the owner includes information for making contact with the owner (for example, the communication address of the terminal of the owner). Specifically, the owner information for vehicle A (partial lease vehicle) indicates that the owner of the vehicle body portion is the vehicle user (the contact therefor is a below-described mobile terminal 20 shown in FIG. 5) and the owner of the power storage device is the lease business entity (the contact therefor is server 520). The owner information for vehicle B (full lease vehicle) indicates that the owner of each of the vehicle body portion and the power storage device is the lease business entity (the contact therefor is server 520). The owner information for vehicle C (sales vehicle) indicates that the owner of each of the vehicle body portion and the power storage device is the vehicle user (the contact therefor is mobile terminal 20).

The owner (for example, the lease business entity) of the power storage device mounted on the vehicle can prove his/her ownership to a third party by, for example, a ownership certificate. The owner can use one node 510 to create an ownership certificate having an attached electronic certificate issued from certification authority 800. The ownership certificate includes, for example, the vehicle ID, the owner information (transaction data) associated with the vehicle ID, the electronic signature, and the time information (time stamp token). The owner information included in the ownership certificate may indicate the owner of the power storage device mounted on the vehicle indicated by the vehicle ID and the owner of the vehicle body portion of the vehicle indicated by the vehicle ID. Node 510 having created the ownership certificate transmits the ownership certificate to the DLN. For a power storage device mounted on a certain vehicle, each node 510 in the DLN obtains, from the DLN, an ownership certificate corresponding to identification information (vehicle ID) of the vehicle, thereby confirming the owner of the power storage device. Further, each node 510 can verify the validity of the ownership certificate using the electronic certificate (including the public key) attached to the ownership certificate. Further, each node 510 can make reference to the distributed ledger so as to confirm a history of the owner information (transaction data) associated with the vehicle ID. Such owner information may satisfy perfection against a third party.

Hereinafter, the vehicle provided by dealer 100 may be referred to as “vehicle 10”. Vehicle 10 according to the present embodiment is one of vehicles A, B, C shown in FIG. 1. FIG. 5 is a diagram for illustrating a configuration of vehicle 10.

Referring to FIG. 5, vehicle 10 includes a vehicle body 11 and a battery 12 mounted on vehicle body 11. Vehicle 10 is configured to travel using electric power of battery 12. Vehicle 10 is, for example, a BEV including no internal combustion engine. As battery 12, a known power storage device for a vehicle (for example, a liquid-type secondary battery or an all-solid-state secondary battery) can be employed. Examples of the secondary battery for a vehicle include a lithium ion battery and a nickel-metal hydride battery. A plurality of such secondary batteries may form a battery assembly. Battery 12 corresponds to an example of the “power storage device” according to the present disclosure.

Vehicle body 11 includes an ECU 111, a battery ECU 112, a BMS (Battery Management System) 112a, a strain sensor 112b, a temperature adjustment system 112c, an inlet 113, a charger 114, an SMR (System Main Relay) 115a, a charging relay 115b, a PCU (Power Control Unit) 116a, an MG (Motor Generator) 116b, an HMI (Human Machine Interface) 117a, a navigation system (hereinafter referred to as “NAVI”) 117b, a drive recorder 117c, a location sensor 118a, an impact force sensor 118b, and a communication device 119. It should be noted that the ECU means an electronic control unit. Electric power is supplied from an auxiliary battery (not shown) to a control system including each ECU mounted on vehicle body 11.

ECU 111 is a computer including a processor 111a and a storage 111b. Storage 111b stores: a program to be executed by processor 111a; and information (for example, a map, a mathematical expression, and various parameters) to be used by the program. Storage 111b further stores various types of information about vehicle 10. These pieces of information are updated in accordance with a situation of vehicle 10. Although the configuration of battery ECU 112 is not shown in FIG. 5, battery ECU 112 is also a computer having a hardware configuration similar to that of ECU 111. ECU 111 and battery ECU 112 are configured to communicate with each other. These ECUs are connected to each other by, for example, a CAN (Controller Area Network).

BMS (Battery Management System) 112a includes a sensor that detects a state (for example, temperature, current, voltage) of battery 12. Strain sensor 112b detects a degree of strain of a case (battery case) of battery 12. As an impact force applied to battery 12 is larger, the degree of strain of the battery case is larger. Strain sensor 112b may be a strain gauge or a displacement sensor. A detection result by each of BMS 112a and strain sensor 112b is output to battery ECU 112.

Temperature adjustment system 112c adjusts a temperature of battery 12. Temperature adjustment system 112c may include at least one of a heater and a cooling device. A cooling method may be a water-cooling method or another method. Temperature adjustment system 112c is controlled by battery ECU 112.

Vehicle 10 is externally chargeable (charging of battery 12 by electric power from outside the vehicle). Inlet 113 is configured such that an EVSE (Electric Vehicle Supply Equipment) plug (for example, a connector of a charging cable) can be attached thereto and detached therefrom. Charger 114 includes a power conversion circuit for the external charging. Charger 114 may include at least one of a DC/DC conversion circuit and an AC/DC conversion circuit. Charging relay 115b switches connection/disconnection of a charging line. In the example shown in FIG. 5, a charging line including inlet 113, charger 114, and charging relay 115b is connected between SMR 115a and PCU 116a. However, it is not limited thereto, and the charging line may be connected between battery 12 and SMR 115a. Further, the configuration shown in FIG. 5 may be changed to attain external power feeding (feeding of electric power from battery 12 to outside the vehicle). For example, charger 114 shown in FIG. 5 may be changed to a charger/discharger.

SMR 115a switches connection/disconnection of an electric path from battery 12 to PCU 116a. During traveling of vehicle 10, SMR 115a is in a connected state, and charging relay 115b is in a disconnected state. When electric power is exchanged between battery 12 and inlet 113, both SMR 115a and charging relay 115b are in the connected state. Each of charger 114, SMR 115a, and charging relay 115b is controlled by battery ECU 112. Battery ECU 112 receives a control command from ECU 111.

PCU 116a drives MG 116b using electric power supplied from battery 12. PCU 116a includes, for example, an inverter and a DC/DC converter. PCU 116a is controlled by ECU 111. MG 116b functions as a traveling motor of vehicle 10. MG 116b is driven by PCU 116a to rotate drive wheels of vehicle 10. MG 116b performs regenerative power generation during braking of vehicle 10, and outputs the generated power to battery 12. It should be noted that any number of traveling motors may be included in vehicle 10.

HMI 117a includes an input device and a display device. HMI 117a may include a touch panel display. HMI 117a may include an instrument panel and/or a head-up display. HMI 117a may include a smart speaker that receives a voice input.

NAVI 117b includes a touch panel display, a GPS (Global Positioning System) sensor, a processor, and a storage that stores map information. The map information indicates the locations of each dealer 100 and each BSta 200 on the map. The map information may be sequentially updated by OTA (Over The Air). NAVI 117b detects the location of vehicle 10 using the GPS sensor, and displays the location of vehicle 10 in real time on the map based on the map information. NAVI 117b makes reference to the map information so as to perform a route search to find an optimal route (for example, the shortest route) from the current location of vehicle 10 to the destination.

Drive recorder 117c includes: a camera that obtains an image around vehicle 10; a storage that stores an image obtained by the camera; and an acceleration sensor (G sensor) that detects acceleration of vehicle 10. Drive recorder 117c always records a video image around vehicle 10. However, when an amount of information of the video image recorded in the storage exceeds the volume of the storage, an old video image is deleted by writing the latest video image over the old video image. Therefore, among video images obtained by drive recorder 117c, a video image that should be retained for a long period of time (for example, below-described accident data) is stored in ECU 111 (storage 111b).

Location sensor 118a detects the location of vehicle 10. Impact force sensor 118b detects an impact force applied to vehicle body 11 (for example, a body shell). Impact force sensor 118b may be configured to detect the impact force using at least one of an acceleration sensor, a strain gauge, and a displacement sensor.

Communication device 119 includes a communication OF (interface) for accessing communication network NW by wireless communication. Communication device 119 may include a TCU (Telematics Control Unit) or DCM (Data Communication Module) that performs wireless communication. Communication device 119 further includes a communication OF for performing wireless communication with each of node 510B and mobile terminal 20. ECU 111 is configured to communicate with each of server 520, node 510B, and mobile terminal 20 through communication device 119. ECU 111 may communicate with each of node 510A and insurance server 600 through communication device 119.

Mobile terminal 20 can be carried by the user. Mobile terminal 20 is carried and operated by the user (vehicle manager) of vehicle 10. In the present embodiment, a smartphone having a touch panel display is employed as mobile terminal 20. The smartphone has a computer therein and has a speaker function. However, it is not limited thereto and any terminal that can be carried by the user of vehicle 10 can be employed as mobile terminal 20. For example, a laptop, a tablet terminal, a portable game machine, a wearable device (such as a smart watch, a smart glass, or a smart glove), or an electronic key can be also employed as mobile terminal 20.

Application software (hereinafter referred to as a “mobile app”) for using the service provided by server 520 is installed in mobile terminal 20. By the mobile app, the identification information (terminal ID) of mobile terminal 20 is registered in server 520 in association with the identification information (vehicle ID) of corresponding vehicle 10. Mobile terminal 20 can exchange information with server 520 through the mobile app. It should be noted that mobile terminal 20 may be configured to communicate with each of insurance server 600 and node 510.

In vehicle 10, ECU 111 performs integrated control for the whole vehicle. ECU 111 obtains detection results from various sensors (including location sensor 118a and impact force sensor 118b) mounted on vehicle 10. ECU 111 also obtains information from each of battery ECU 112, HMI 117a, NAVI 117b, drive recorder 117c, and communication device 119. Battery ECU 112 obtains a state (temperature, current, voltage, or the like) of battery 12 based on an output of BMS 112a, and outputs the obtained state of battery 12 to ECU 111. The vehicle information obtained by ECU 111 is stored into storage 111b.

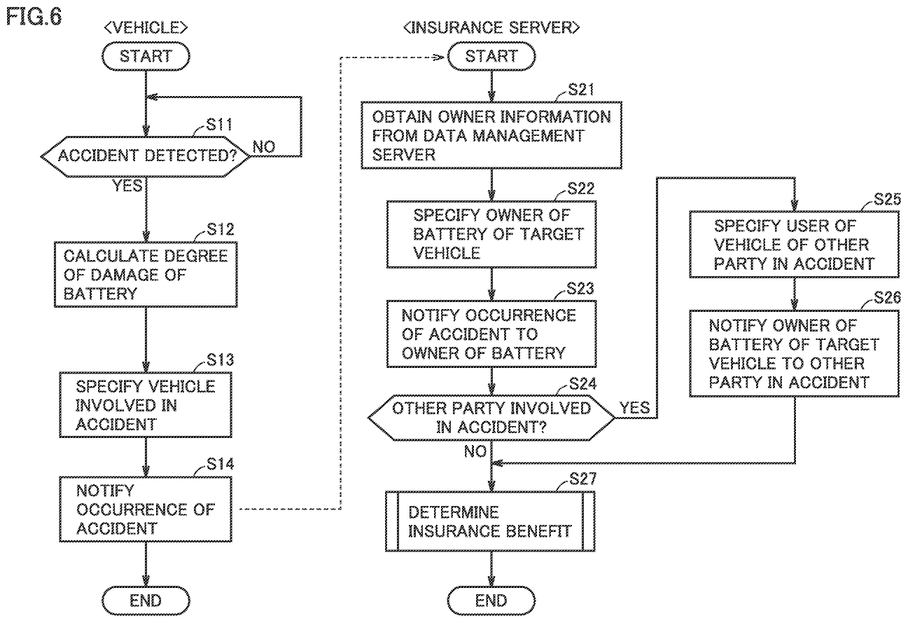

FIG. 6 is a flowchart showing control at the time of occurrence of an accident in a management method for managing a power storage device according to the present embodiment. Hereinafter, each step in the flowchart is simply described as “S”.

For example, when ECU 111 of vehicle 10 is activated, ECU 111 having been activated starts a process of S11 described below. ECU 111 is activated in response to, for example, an operation on an activation switch of vehicle 10. Generally, the activation switch is referred to as “power switch”, “ignition switch”, or the like. It should be noted that the process of S11 may be performed for any period of time. For example, ECU 111 may perform the process of S11 only during traveling of vehicle 10. In the process shown in FIG. 6, vehicle 10 that performs S11 and subsequent processes will be referred to as “target vehicle”.

Referring to FIG. 6 as well as FIGS. 1 and 5, in S11, ECU 111 of the target vehicle determines whether or not an accident has occurred with regard to the target vehicle. For example, when an impact force detected by impact force sensor 118b exceeds a predetermined threshold value, ECU 111 determines that an accident has occurred with regard to the target vehicle. In this case, accident data (for example, a video image of drive recorder 117c) indicating a situation of the target vehicle before and after the accident is stored into storage 111b. On the other hand, when the impact force detected by impact force sensor 118b is equal to or less than the predetermined threshold value, ECU 111 determines that no accident has occurred with regard to the target vehicle. When it is determined that no accident has occurred (NO in S11), the process does not proceed to S12 and the subsequent steps, and the determination in S11 is repeated. It should be noted that instead of impact force sensor 118b, the acceleration sensor of drive recorder 117c may be used to detect an impact force.

When it is determined that an accident has occurred (YES in S11), ECU 111 of the target vehicle calculates a degree of damage of battery 12 mounted on the target vehicle in S12. In the present embodiment, ECU 111 calculates the degree of damage of battery 12 based on at least one of a degree of physical damage of the case of battery 12 (for example, a degree of strain of the battery case as detected by strain sensor 112b), a communication level (for example, destabilization of communication, breakdown of communication, or the like) for a system that monitors battery 12, a degree of damage of an electrical component of battery 12 (for example, disconnection of a line, deformation of a bus bar, or the like), and a degree of damage (for example, control malfunction, failure, or the like) of an environmental system for battery 12. In the present embodiment, each of battery ECU 112 and BMS 112a functions as the system that monitors battery 12. Temperature adjustment system 112c functions as the environmental system for battery 12. ECU 111 may score respective degrees of damage for evaluation items with regard to the degree of damage of battery 12, and may handle a total value of the scores for the respective evaluation items as the degree of damage (evaluation result) of battery 12. The evaluation items may be the above-described four items (the case, the communication level, the electrical component, and the environment system), or may be one or more and three or less items selected from these items.

A method of finding the degree of damage of battery 12 is not limited to the method described above, and any method can be employed. For example, ECU 111 may calculate the degree of damage of battery 12 due to the accident based on a change in characteristic of battery 12 before and after the accident (for example, a degree of decrease in capacity retention or a degree of increase in internal resistance).

Then, ECU 111 of the target vehicle specifies a vehicle involved in the accident in S13. Specifically, ECU 111 determines, based on the accident data (for example, the video image of drive recorder 117c described above) indicating the situation of the target vehicle when the accident has occurred, whether the accident is a single-vehicle accident involving only the target vehicle or is an accident between the target vehicle and another vehicle. When the other vehicle (vehicle of the other party in the accident) exists, ECU 111 obtains the identification information (vehicle ID) of the vehicle of the other party in the accident. When the vehicle ID of the other party in the accident cannot be specified from the accident data, ECU 111 of the target vehicle may request the user terminal (for example, mobile terminal 20) of the target vehicle to input information for specifying the vehicle ID of the other party in the accident.

Then, in S14, ECU 111 of the target vehicle transmits, to insurance server 600, an accident occurrence signal that informs the occurrence of the accident, damage information indicating the degree of damage of battery 12 as obtained in S12, and accident data indicating the situation of the target vehicle when the accident has occurred. The accident occurrence signal includes, for example, the location information of the location of the accident site detected by location sensor 118a of the target vehicle, and the identification information (vehicle ID) of each vehicle involved in the accident. In the case of the single-vehicle accident, the accident occurrence signal only includes the identification information of the target vehicle. When the vehicle of the other party in the accident exists, the accident occurrence signal further includes the identification information of the vehicle of the other party in the accident in addition to the identification information of the target vehicle. When the process of S14 is performed, the series of processes by the target vehicle are ended.

When the accident occurrence signal (S14) is received from the target vehicle, insurance server 600 starts a series of processes of S21 to S27 described below.

In S21, insurance server 600 obtains the owner information of each vehicle involved in the accident from management center 500 (more specifically, the distributed ledger held by management center 500) based on the vehicle ID included in the accident occurrence signal. The owner information of the vehicle includes: first owner information indicating the owner of the power storage device mounted on the vehicle; and second owner information indicating the owner of the vehicle body portion of the vehicle.

Next, in S22, insurance server 600 specifies the owner of battery 12 mounted on the target vehicle using the owner information of the target vehicle as obtained in S21. Then, in S23, insurance server 600 provides, to the terminal of the owner of battery 12 as specified in S22, a notification that informs the occurrence of the accident with regard to the target vehicle and the location of the accident site. When the target vehicle is vehicle A or vehicle B, insurance server 600 specifies the communication address of server 520 (the terminal of the owner of battery 12) based on the owner information of the target vehicle, and provides, to server 520, the notification that informs the occurrence of the accident of the target vehicle. When the target vehicle is vehicle C, insurance server 600 specifies the communication address of mobile terminal 20 (the terminal of the owner of battery 12) corresponding to the target vehicle based on the owner information of the target vehicle, and provides, to mobile terminal 20, the notification that informs the occurrence of the accident of the target vehicle.

In the present embodiment, when the accident occurrence signal (including the information indicating that the accident has occurred with regard to the target vehicle) is obtained, insurance server 600 performs the processes of S22, S23. Specifically, insurance server 600 obtains the first owner information of the target vehicle from management center 500 (S21), specifies the owner of the power storage device of the target vehicle using the obtained first owner information (S22), and provides, to the terminal of the specified owner of the power storage device, a notification that informs the occurrence of the accident of the target vehicle (S23). Thus, at the time of occurrence of the vehicle accident, it is possible to accurately inform the occurrence of the accident to the owner of the power storage device included in the target vehicle.

Next, in S24, insurance server 600 determines whether or not the vehicle of the other party in the accident exists, based on the accident occurrence signal (S14). When the accident occurrence signal indicates a single-vehicle accident, NO is determined in S24, and the process proceeds to S27.

When the accident occurrence signal indicates that the accident is not a single-vehicle accident (i.e., indicates that the vehicle of the other party in the accident exists) (YES in S24), insurance server 600 specifies in S25 the user of the vehicle of the other party in the accident using the owner information of the vehicle of the other party in the accident as obtained in S21. For example, when the vehicle of the other party in the accident is vehicle A or vehicle C, insurance server 600 directly specifies the user of the vehicle of the other party in the accident in accordance with the information (second owner information) indicating the owner of the vehicle body portion of the vehicle of the other party in the accident. On the other hand, when the vehicle of the other party in the accident is vehicle B, insurance server 600 obtains, from server 520 (the terminal of the owner of the vehicle body portion), information for specifying the user of the vehicle of the other party in the accident (for example, the communication address of mobile terminal 20 corresponding to the vehicle of the other party in the accident).

Then, in S26, insurance server 600 provides, to the terminal of the user of the vehicle of the other party in the accident as specified in S25 (for example, mobile terminal 20 corresponding to the vehicle of the other party in the accident), a notification that informs the owner of battery 12 mounted on the target vehicle. Then, the process proceeds to S27.

In the present embodiment, when the accident occurrence signal indicating that the accident has occurred between the target vehicle and the other vehicle is obtained, insurance server 600 obtains, from management center 500 in S21, the first owner information indicating the owner of the power storage device of the target vehicle and the second owner information indicating the owner of the vehicle body portion of the other vehicle, and performs the processes of S25 and S26. Specifically, insurance server 600 specifies the user of the other vehicle using the second owner information obtained in S21 (S25), and provides, to the terminal of the specified user of the other vehicle, a notification that informs the owner of the power storage device of the target vehicle (S26). Thus, when the power storage device of the target vehicle is damaged by the accident, a negotiation about compensation for the damage can be facilitated between the user of the vehicle of the other party in the accident (or an insurance business entity having made a contract with the user) and the lease business entity for the power storage device (or an insurance business entity cooperating with the lease business entity).

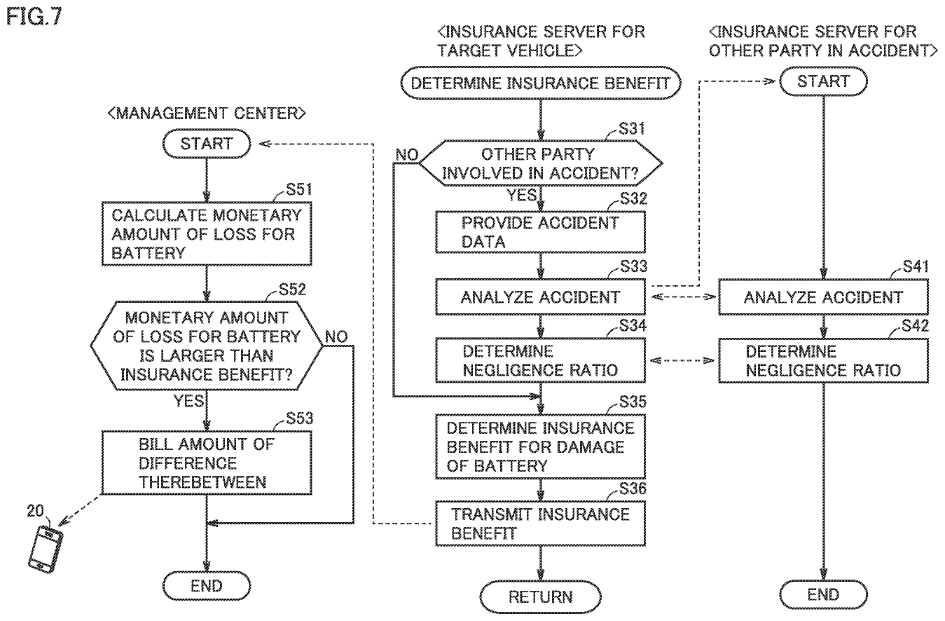

In S27, insurance server 600 performs a below-described series of processes of S31 to S36 shown in FIG. 7. FIG. 7 is a flowchart showing a process, performed by insurance server 600, for providing the insurance service.

Referring to FIG. 7 as well as FIG. 1 and FIG. 5, in S31, insurance server 600 determines whether or not the vehicle of the other party in the accident exists, as with the case of S24 of FIG. 6. In the case of the single-vehicle accident, NO is determined in S31, and the process proceeds to S35.

When the vehicle of the other party in the accident exists (YES in S31), insurance server 600 specifies in S32 the server of the insurance business entity (the insurance server for the other party in the accident) that provides the insurance in which the vehicle of the other party in the accident is enrolled, and provides the accident data (S14 in FIG. 6) received from the target vehicle to the insurance server for the other party in the accident. When the insurance server for the other party in the accident cannot be specified in accordance with the accident data, insurance server 600 may request, to the user terminal (for example, mobile terminal 20) of the target vehicle and/or the user terminal of the vehicle of the other party in the accident, information for specifying the insurance server for the other party in the accident. Prior to providing (transmitting) the accident data, insurance server 600 may provide a notification for explaining the situation to the insurance server for the other party in the accident.

By the process of S32, the accident data is shared between insurance server 600 of the target vehicle and the insurance server for the other party in the accident. Thereafter, an accident analysis based on the accident data is performed by each of these insurance servers (S33, S41), and a negligence ratio of the user of the target vehicle is determined based on the result of the accident analysis (S34, S42). As the negligence ratio is larger, a degree of negligence is larger.

Then, in S35, insurance server 600 determines an insurance benefit to be paid by the insurance service, based on the damage information (S14 in FIG. 6) received from the target vehicle and the negligence ratio (S34) of the vehicle user with regard to the accident.

In the case of the single-vehicle accident (self-injury accident), insurance server 600 may determine the insurance benefit based only on the damage information in S35. However, when it is recognized from the accident data that the user has intentionally damaged battery 12, insurance server 600 may determine that the damage is not covered by the insurance (no insurance benefit).

Next, in S36, insurance server 600 transmits, to server 520, a signal (hereinafter, also referred to as “insurance signal”) that includes: the vehicle ID of the target vehicle; the damage information indicating the degree of damage of battery 12 of the target vehicle; and the information indicating the insurance benefit determined in S35. The insurance signal may include information indicating the negligence ratio of the vehicle user with regard to the accident. When the process of S36 is performed, the series of processes of S31 to S36 by insurance server 600 (S27 in FIG. 6) are ended, and a series of processes of S51 to S53 by server 520 are started.

In S51, server 520 uses the damage information to find a monetary amount of loss due to the damage of battery 12. Next, in S52, server 520 determines whether or not the monetary amount of loss due to the damage of battery 12 (S51) is larger than the insurance benefit indicated by the insurance signal. When the monetary amount of loss due to the damage of battery 12 is larger than insurance benefit (YES in S52), server 520 provides, to the user terminal (for example, mobile terminal 20) of the target vehicle, a notification that bills an amount of difference therebetween (=the monetary amount of loss−the insurance benefit) in S53. On the other hand, when the monetary amount of loss due to the damage of battery 12 is equal to or less than the insurance benefit (NO in S52), server 520 does not bill to the vehicle user (S53). It should be noted that a loss in the vehicle body portion when the target vehicle is vehicle B (full lease vehicle) may be compensated for by the insurance benefit, or the lease business entity (automobile manufacturer) may bill at least a part of the loss to the vehicle user.

By performing the series of processes shown in FIG. 7, S27 of FIG. 6 is completed, and the series of processes by insurance server 600 shown in FIG. 6 are ended. In the present embodiment, in S14 of FIG. 6, the target vehicle for which the accident has occurred transmits: the accident occurrence signal informing the occurrence of the accident; the damage information indicating the degree of damage of the power storage device mounted on the target vehicle; and the accident data indicating the situation of the target vehicle when the accident has occurred. When the accident occurrence signal is received, insurance server 600 performs the series of processes shown in FIGS. 6 and 7. Specifically, insurance server 600 determines the degree of negligence of the user of the target vehicle with regard to the accident based on the accident data (S34 in FIG. 7), and determines the insurance benefit to be paid by the insurance service based on the damage information and the degree of negligence (S35 in FIG. 7). Thus, the insurance benefit can be facilitated to be appropriately determined. Further, the user of the target vehicle can be facilitated to receive the insurance service.

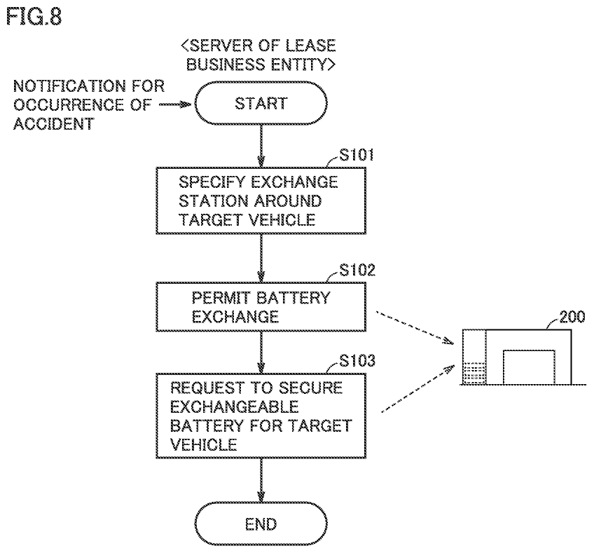

When the notification of the occurrence of the accident (S23 in FIG. 6) is received from insurance server 600, server 520 starts a below-described series of processes shown in FIG. 8. In the present embodiment, the reception of the notification of occurrence of the accident by server 520 means that the accident has occurred with regard to vehicle A or vehicle B.

FIG. 8 is a flowchart showing control performed by server 520 at the time of occurrence of the accident in the management method for managing a power storage device according to the present embodiment. Referring to FIG. 8 as well as FIG. 1 and FIG. 5, in S101, server 520 specifies one or more BStas 200 existing around the accident site based on the location of the accident site (S23 in FIG. 6) as notified from insurance server 600. The one or more BStas 200 existing around the location of the accident site may be one BSta 200 closest to the accident site, or may be at least one BSta 200 existing within a predetermined distance from the location of the accident site.

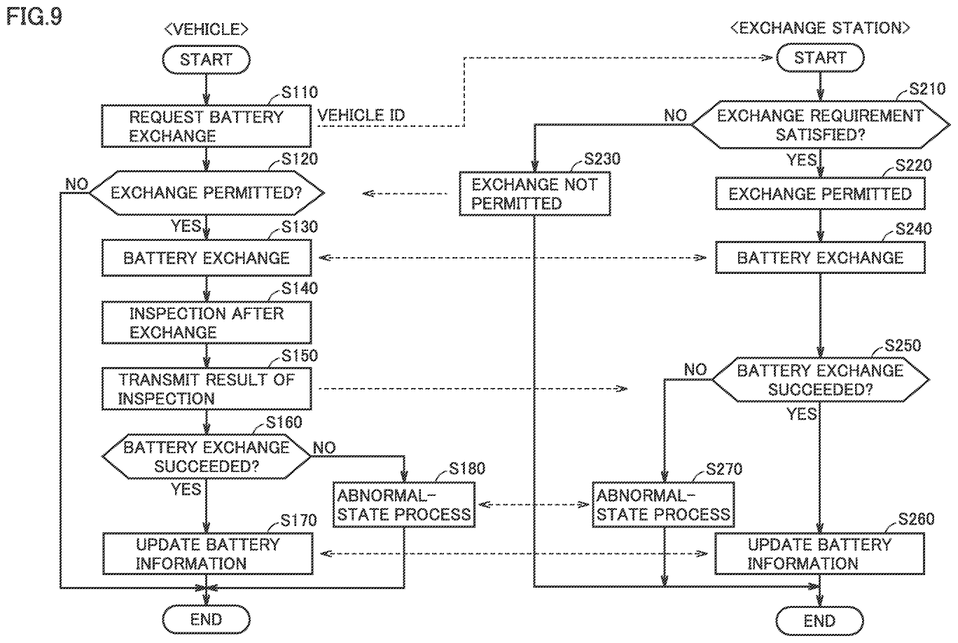

Next, in S102, server 520 permits node 510B of each of one or more BStas 200 specified in S101 to exchange battery 12 mounted on the target vehicle. Specifically, server 520 transmits an exchange permission signal including the identification information (vehicle ID) of the target vehicle to node 510B. The exchange of the battery of the target vehicle by BSta 200 is permitted by the exchange permission signal. Node 510B specifies the vehicle to be subject to the battery exchange, based on the vehicle ID included in the exchange permission signal. The vehicle ID included in the exchange permission signal is registered in node 510B, and a reservation for the battery exchange of the target vehicle indicated by the vehicle ID is made in node 510B. Node 510B can perform the reserved battery exchange by a below-described process shown in FIG. 9. It should be noted that the reservation may be canceled when the battery exchange is not performed even after a predetermined period of time has elapsed since the reservation for the battery exchange was made.

Then, in S103, server 520 requests node 510B of each of one or more BSta 200 specified in S101 to secure a power storage device (exchangeable battery) that can be exchanged with battery 12 mounted on the target vehicle. Specifically, server 520 extracts the specification information for battery 12 of the target vehicle from the distributed ledger stored in storage 522 based on the identification information (vehicle ID) of the target vehicle, and transmits the extracted specification information to node 510B, thereby making the above request to node 510B. Node 510B having received this request checks whether or not the exchangeable battery requested from server 520 is in short, and when the exchangeable battery is in short, node 510B secures the exchangeable battery (power storage device for the target vehicle) from a nearby warehouse or another BSta 200.

In the present embodiment, when the notification (S23 in FIG. 6) that informs the occurrence of the accident of the target vehicle is received, server 520 performs the processes of S101 to S103. Specifically, in S102, server 520 (the terminal of the owner of the power storage device of the target vehicle) permits one or more BStas 200 (exchange stations) to exchange the power storage device of the target vehicle. Thus, when the accident has occurred with regard to the target vehicle, the power storage device mounted on the target vehicle can be facilitated to be exchanged at the exchange station. Further, with the process of S103, immediate battery exchange after the accident is facilitated.

The target vehicle for which the accident has occurred travels by itself or is carried by a tow truck to arrive at a BSta 200 (for example, BSta 200 closest to the accident site) existing around the accident site. Then, in BSta 200, battery 12 mounted on the target vehicle is exchanged. FIG. 9 is a flowchart showing a process for the battery exchange as performed by the target vehicle and the battery exchange station terminal (node 510B).

Referring to FIG. 9 as well as FIGS. 1 and 5, a series of processes of S110 to S180 are performed by ECU 111 of the target vehicle. A series of processes of S210 to S270 are performed by node 510B. Node 510B is configured to wirelessly communicate with the target vehicle, and obtains battery information from the target vehicle. Node 510B and the target vehicle may perform short-range communication via a wireless LAN (Local Area Network) or may perform communication via communication network NW, for example.

After arriving at BSta 200, the target vehicle transmits, to node 510B, a signal (hereinafter also referred to as “request signal”) that requests the battery exchange in S110. The request signal includes the identification information (vehicle ID) of the target vehicle. Hereinafter, battery 12 included in the target vehicle before the exchange will be referred to as “battery B1”. The target vehicle may make the request for the battery exchange (S110) in response to an instruction from the user.

In S210, node 510B having received the request signal determines whether or not a predetermined exchange requirement for the target vehicle is satisfied. Specifically, node 510B determines whether or not the exchange requirement is satisfied, based on whether or not the vehicle ID included in the request signal coincides with the vehicle ID included in the exchange permission signal (S102 in FIG. 8). That is, when the vehicle ID of the target vehicle is registered (reserved), the exchange requirement is satisfied, whereas when the vehicle ID of the target vehicle is not registered (reserved), the exchange requirement is not satisfied.

When the exchange requirement for the target vehicle is satisfied (YES in S210), node 510B sends a notification of permission to the target vehicle in S220, and then the process proceeds to S240. On the other hand, when the exchange requirement for the target vehicle is not satisfied (NO in S210), node 510B sends a notification of non-permission to the target vehicle in S230, and then the series of processes of S210 to S270 are ended. In this case, the battery exchange is not performed.

After transmitting the request signal (S110), the target vehicle waits for a reply from node 510B. When the reply from node 510B is received, the target vehicle determines whether or not the battery exchange is permitted in S120. When the target vehicle receives the notification of permission (YES in S120), the process proceeds to S130. On the other hand, when the target vehicle receives the notification of non-permission (NO in S120), the series of processes of S110 to S180 are ended. In this case, the battery exchange is not performed.

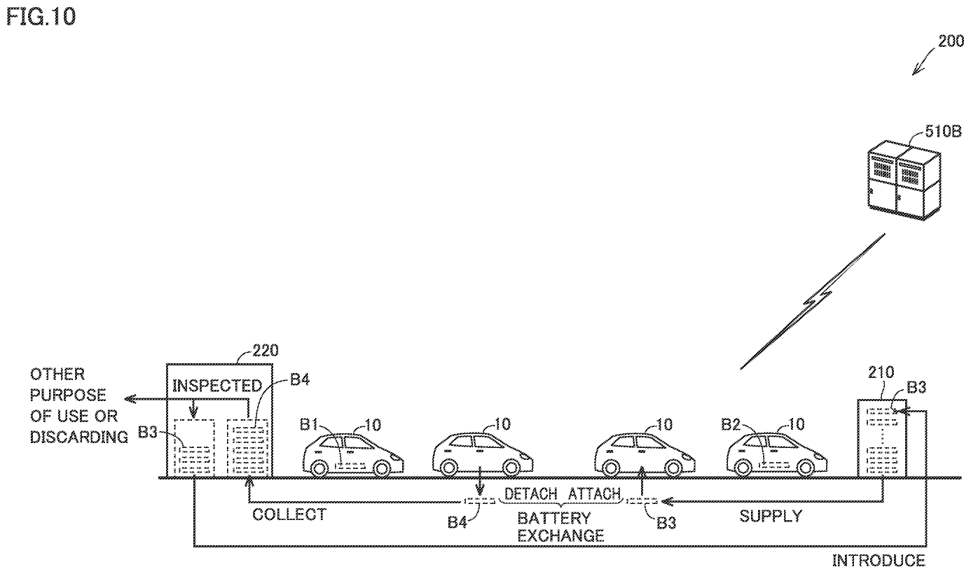

In each of S130, S240, the battery exchange is performed in a below-described procedure (see FIG. 10). The target vehicle and node 510B exchange information for the battery exchange.

Hereinafter, battery 12 attached to the target vehicle by the battery exchange will be referred to as “battery B2”. When the battery exchange is completed, the target vehicle performs an inspection on battery B2 in S140. Then, in S150, the target vehicle transmits a result of the inspection to node 510B. Then, in S160, the target vehicle determines, in accordance with the result of the inspection, whether or not the battery exchange has succeeded. When no abnormality (for example, connection failure or abnormality in electrical performance) is found by the inspection, the target vehicle determines that the battery exchange has succeeded, whereas when an abnormality is found by the inspection, the target vehicle determines that the battery exchange has failed. Similarly, in S250, node 510B having received the result of the inspection determines, in accordance with the result of the inspection, whether or not the battery exchange has succeeded (presence/absence of abnormality).

When the battery exchange has succeeded (YES in S160 and YES in S250), the target vehicle and node 510B update the respective pieces of battery information (specification information) held by themselves in S170 and S260, and then the series of processes shown in FIG. 9 are ended. In S260, node 510B may update the distributed ledger managed by management center 500. On the other hand, when the battery exchange has failed (NO in S160 and NO in S250), the target vehicle and node 510B each perform predetermined abnormal-state process in S180 and S270. The abnormal-state process may include a process of notifying the user of the target vehicle that the battery exchange has failed. The abnormal-state process may include a process of notifying server 520 that the battery exchange has failed. Further, the abnormal-state process may include a process of temporarily detaching, from the target vehicle, battery B2 having been attached to the target vehicle, and performing the battery exchange again. After the abnormal-state process is performed, the series of processes shown in FIG. 9 are ended. It should be noted that the abnormal-state process can be arbitrarily set.

FIG. 10 is a diagram for illustrating configuration and operation of the battery exchange station (BSta 200) according to the present embodiment.

Referring to FIG. 10, BSta 200 includes a safekeeping device 210 and an inspection unit 220. Safekeeping device 210 includes an accommodation portion (for example, a storage compartment). Inspection unit 220 includes, for example, a charger/discharger, a measurement device, and a sorting device. BSta 200 further includes: a transporting device that transports the power storage device; and an exchange device that exchanges the power storage device. A transporting method may be a conveyor method or a method using a transporting robot. Each of the transporting device and the exchange device is controlled by node 510B.

Storage 512 (FIG. 2) of node 510B stores pieces of information about respective batteries existing in BSta 200 with the pieces of information about the respective batteries being distinguished by the respective pieces of identification information (battery ID) of the batteries. The battery information held by node 510B includes, for example, a specification (a capacity in an initial state, charging performance, discharging performance, or the like), a status (for example, one of pre-inspection/post-inspection (reuse/other purpose of use/discarding)/suppliable), an SOH (State of Health), and an SOC (State Of Charge).

It should be noted that the SOC represents an remaining amount of stored power, and corresponds to a ratio of an amount of stored power at present to an amount of stored power in a fully charged state. The SOH represents a degree of health or deterioration. Examples of the SOH include a capacity retention and an internal resistance. A larger internal resistance of the power storage device means a larger degree of deterioration of the power storage device. A lower capacity retention of the power storage device means a larger degree of deterioration of the power storage device. The capacity retention of the power storage device corresponds to a ratio of the capacity of the power storage device at present to the capacity of the power storage device in the initial state (state with no deterioration). The capacity of the power storage device corresponds to the amount of stored power in the fully charged state.

Node 510B may write, in the distributed ledger managed by management center 500, the information (the battery ID, the specification, the SOH, or the like) about each battery B3 (power storage device that can be supplied) accommodated in the accommodation portion of safekeeping device 210, as well as the location information of BSta 200. Such information is useful in battery inventory management. Each of the battery existing in BSta 200 is an object owned by the automobile manufacturer. A new battery may be supplied from a warehouse of the automobile manufacturer to BSta 200, or a used battery collected from a vehicle 10 may be kept in BSta 200. Also, a battery may be transferred between a plurality of BStas 200.

After the target vehicle is parked at a predetermined location in BSta 200, the target vehicle requests the battery exchange to node 510B (S110 in FIG. 9). In response to this request, node 510B starts control for the battery exchange (S240 in FIG. 9). Node 510B exchanges the battery of the target vehicle in, for example, the following procedure.

Node 510B selects a battery (exchangeable battery) corresponding to battery B1 from the plurality of batteries B3 accommodated in the accommodation portion of safekeeping device 210. The selected battery B3 has the same specification (for example, capacity in the initial state, charging performance, and discharging performance) as that of battery B1. However, the degree of deterioration of battery B3 is smaller than the degree of deterioration of battery B1. Further, the SOC of battery B3 is equal to or more than a predetermined SOC value (for example, 50%).

Then, the exchange device detaches battery B1 from the target vehicle. Hereinafter, the battery detached from the target vehicle will be referred to as “battery B4”. Then, the transporting device transports (supplies) battery B3 from safekeeping device 210 to the exchange device. Then, the exchange device attaches the supplied battery B3 to the target vehicle. In this way, the battery exchange for the target vehicle is completed.

Further, BSta 200 performs a reuse process for battery B4 detached from the target vehicle, in parallel with the above-described battery exchange process. When battery B4 is detached from the target vehicle, node 510B starts control for battery reuse. The reuse process is performed, for example, in the following procedure.

The transporting device transports (collects) battery B4 to inspection unit 220. Then, inspection unit 220 performs an inspection on the collected battery B4. The inspection is performed by the charger/discharger and the measurement device of inspection unit 220. Before the inspection, an SOH recovery process may be performed onto battery B4.

In the above inspection, for example, the charger/discharger discharges battery B4 until the SOC becomes equal to or lower than a predetermined first SOC value (for example, an SOC value indicating an empty charge state), and then charges battery B4 until the SOC becomes equal to or higher than a predetermined second SOC value (for example, an SOC value indicating the fully charged state). The measurement device includes various sensors and measures the state (for example, temperature, current, and voltage) of battery B4 during the charging and/or the discharging. Then, the measurement device detects the SOH of battery B4 in accordance with the measured data. It should be noted that the measurement device may further include a camera for inspection on an external appearance. Further, the charger/discharger may repeat the charging/discharging of battery B4 until the measurement device obtains necessary inspection data.

When the above-described inspection is completed, the sorting device of inspection unit 220 sorts, in accordance with the inspection result, battery B4 to one of reuse as a vehicle battery, use for another purpose of use (purpose of use other than use for a vehicle), and discarding. Examples of the other purpose of use include use as a stationary battery. Any method of discarding the battery is employed. The battery may be disassembled to a material level to collect a renewable material for the sake of recycling (resource recycling) in the course of discarding. It should be noted that the sorting device may classify battery B4 having a significantly damaged external appearance as being not reusable (the other purpose of use or the discarding).

Battery B4 reusable as a battery for a vehicle is handled as battery B3 described above. After the inspection, the transporting device transports battery B3 to safekeeping device 210. Transported battery B3 is introduced into safekeeping device 210. Thus, battery B3 having been inspected and charged is set in safekeeping device 210 and can be supplied. However, it is not limited thereto, and safekeeping device 210 may be configured to charge battery B3 having been inspected.

FIG. 10 shows an example in which the detachment of the battery and the attachment of the battery are performed at different places. The target vehicle may be transported from a detachment location to an attachment location by a transporting device (for example, a conveyor-type transporting device) (not shown). However, it is not limited thereto, and the detachment of the battery and the attachment of the battery may be performed at the same place. The battery exchange (detachment and attachment) may be performed in a stationary state of the target vehicle (for example, a parked state). It is not essential that the battery before the exchange and the battery after the exchange have the same specification. The vehicle-mounted battery may be exchanged with a battery having a different specification. For example, the capacity of the vehicle-mounted battery may be increased by the battery exchange.

As described above, the management method for managing a power storage device according to the present embodiment includes each of the processes shown in FIGS. 6 to 9. In the present embodiment, insurance server 600 corresponds to an example of the “computer device” according to the present disclosure. Each process is performed by one or more processors executing a program stored in one or more memories. However, these processes may be performed by dedicated hardware (electronic circuit) instead of software.

In the above-described embodiment, by the common processing flow for vehicle A (partial lease vehicle) and vehicle B (full lease vehicle), the insurance benefit for the damage of the power storage device is calculated (see FIG. 7). However, it is not limited thereto, and the insurance benefit may be calculated by different processing flows for vehicle A and vehicle B. For example, insurance server 600 may perform the processing flow shown in FIG. 7 for vehicle A and may perform another processing flow (not shown) for vehicle B. For vehicle B, insurance server 600 may provide an insurance service that compensates for not only the damage of the power storage device but also the damage of the vehicle body.

The processing flow shown in FIGS. 6 to 9 can be changed as appropriate. For example, the order of the processes may be changed or unnecessary steps may be omitted depending on a purpose. Further, the content of any process may be changed. In the above-described embodiment, insurance server 600 obtains both the first owner information and the second owner information in S21 of FIG. 6; however, insurance server 600 may obtain only the first owner information from management center 500.

Further, in an implementation in which the first owner information (information indicating the owner of the vehicle-mounted power storage device) is included in the authentication information (for example, automobile inspection and registration information) of the vehicle as managed by the data management device of the authority, insurance server 600 may obtain the first owner information (authentication information) from the data management device of the authority in S21 of FIG. 6.

Management center 500 may manage the first owner information as battery passport information. Further, management center 500 may request a permission to the owner indicated by the owner information when transmission of the owner information is requested from insurance server 600, and may transmit the owner information to insurance server 600 only when the permission is obtained from the owner. In the present embodiment, each of node 510, server 520, and insurance server 600 is an on-premise server. However, it is not limited thereto and the function of each server may be implemented on cloud by cloud computing. That is, each of these servers may be a cloud server. It is not essential for the data management device to manage information about the sales vehicle. The data management device may manage only information about the lease vehicle. The location to provide the lease service is not limited to dealer 100. For example, server 520 may provide the lease service online (for example, on cloud). Further, only one type of lease method may be employed (for example, the partial lease method).

In the above-described embodiment, only the battery is exchanged, but a battery pack including the battery and its accessory component (for example, at least one of the battery ECU, the BMS, the strain sensor, the temperature adjustment system, and the SMR) may be collectively exchanged. The vehicle may be an xEV (electrically powered vehicle) other than the BEV. The vehicle may include an internal combustion engine. The vehicle is not limited to a passenger vehicle having four wheels, and may be a bus or a truck, or may be an xEV having three wheels or five or more wheels. The vehicle may include a solar panel. The vehicle may be chargeable wirelessly. The vehicle may be configured to perform automated driving or may have a flying function. The vehicle may be a vehicle that can travel with no crew (for example, a robotic taxi, an uncrewed transporting vehicle, or an agricultural machine).

Although the embodiments of the present invention have been described and illustrated in detail, it is clearly understood that the same is by way of illustration and example only and is not to be taken by way of limitation, the scope of the present invention being interpreted by the terms of the appended claims. The scope of the present disclosure is defined by the terms of the claims, and is intended to include any modifications within the scope and meaning equivalent to the terms of the claims.

What is claimed is:

1. A management method for managing a power storage device, the management method comprising:
when information indicating that an accident has occurred with regard to a target vehicle including a power storage device is obtained, obtaining first owner information indicating an owner of the power storage device from a data management device that manages information about a plurality of vehicles including the target vehicle;
specifying the owner of the power storage device using the obtained first owner information; and
providing, to a terminal of the specified owner of the power storage device, a notification that informs the occurrence of the accident of the target vehicle.

2. The management method for managing a power storage device according to claim 1, wherein
the data management device manages information indicating an owner of a vehicle-mounted power storage device and an owner of a vehicle body portion with regard to each of the plurality of vehicles,
the management method comprising:
when information indicating that an accident has occurred between the target vehicle and another vehicle is obtained, obtaining, from the data management device, the first owner information about the power storage device and second owner information indicating an owner of a vehicle body portion of the other vehicle;
specifying a user of the other vehicle using the obtained second owner information; and
providing, to a terminal of the specified user of the other vehicle, a notification that informs the owner of the power storage device.

3. A computer device comprising a processor and a storage that stores a program for causing the processor to perform the management method for managing a power storage device according to claim 1.

4. A management system for managing a power storage device, the management system including the computer device according to claim 3 and the data management device, wherein
the data management device includes
a storage that stores a distributed ledger, and
a controller that registers, in the distributed ledger, transaction data including information indicating an owner of a vehicle-mounted power storage device with regard to each of the plurality of vehicles.

5. The management system for managing a power storage device according to claim 4, wherein
the computer device is a first server that provides an insurance service for damage of a power storage device for a vehicle,
the target vehicle for which the accident has occurred transmits an accident occurrence signal informing the occurrence of the accident, damage information indicating a degree of damage of the power storage device, and accident data indicating a situation of the target vehicle when the accident has occurred, and
when the first server receives the accident occurrence signal, the first server performs
determining a degree of negligence of a user of the target vehicle with regard to the accident based on the accident data, and
determining an insurance benefit to be paid by the insurance service, based on the damage information and the degree of negligence.

6. The management system for managing a power storage device according to claim 4, further comprising a plurality of exchange stations that each exchange a power storage device for a vehicle,
the terminal of the owner of the power storage device is a second server that provides a lease service for leasing a power storage device for a vehicle, and
when the second server receives the notification that informs the occurrence of the accident of the target vehicle, the second server permits one or more of the exchange stations to exchange the power storage device.
